(19) United States
(12) Patent Application Publication
(10) Pub. No.: US 2010/0307410 A1
(43) Pub. Date: Dec. 9, 2010

(54) CHEMICAL LIQUID RECOVERY CUP AND CHEMICAL LIQUID COATING DEVICE

(75) Inventor: Katsuhiro Yoshino, Miyazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/765,939

(22) Filed: Apr. 23, 2010

(30) Foreign Application Priority Data
Jun. 5, 2009 (JP) 2009-136163

(51) Int. Cl. B05C 11/10; B05C 13/00

(52) U.S. Cl. 118/500; 118/506

(57) ABSTRACT

In the present invention, at a coater cup 18 of a resist coating device 10, a through-hole 46 is formed in a top wall 38 of an upper cup 24 that is formed of a resin material. A silicon substrate 16 is held at a rotating chuck 14 that passes-through the through-hole 46. A reverse surface of the silicon substrate 16 thereby faces a top surface of the top wall 38 of the upper cup 24. Here, a deformation correcting hardware 48 is mounted to the top wall 38 of the upper cup 24 along a hole edge portion of the through-hole 46 (i.e., along a pushed-out portion 38A). Because the deformation correcting hardware 48 is formed to have higher rigidity than the top wall 38 of the upper cup 24, deformation of the top wall 38 can be corrected or suppressed by the deformation correcting hardware 48.

### CROSS-REFERENCE TO RELATED APPLICATION

This application claims priority under 35 USC 119 from Japanese Patent Application No. 2009-136163 filed on Jun. 5, 2009, the disclosure of which is incorporated by reference herein.

### BACKGROUND

### Technical Field

The present invention relates to a chemical liquid coating device that coats a chemical liquid on the surface of a substrate, and to a chemical liquid recovery cup that is mounted to the chemical liquid coating device.

Conventionally, resist coating devices called spin coaters are used in the process of fabricating a semiconductor integrated circuit (see, for example, Japanese Patent Application Laid-Open (JP-A) No. 2002-246301). In such a resist coating device, while a silicon substrate is fixed to a rotating chuck, that can be raised and lowered, and is rotated, a photoresist liquid is supplied to and coated on the surface of the silicon substrate. A waste liquid separating cup, that is for separating and recovering the photoresist liquid that scatters from the silicon substrate, is provided at a periphery of the silicon substrate. The waste liquid separating cup is structured by plural cups, that are formed of a resin material, being combined vertically. At one of these cups, there is a flow regulating plate (upper cup) that is disposed at the lower side of the silicon substrate. A through-hole through which the rotating chuck passes is formed in the central portion of the top wall of the flow regulating plate. The top surface of this top wall is disposed so as to face the reverse surface of the silicon substrate. The gap between the top wall and the silicon substrate is managed so as to be within a range of, for example, 2 mm±0.5 mm in a state in which the silicon substrate has been lowered together with the rotating chuck.

In the waste liquid separating cup (chemical liquid recovery cup) as described above, the flow regulating plate (upper cup) is made of resin, the wall thickness thereof is thin, and the flow regulating plate easily deforms. Therefore, there is the drawback that it is difficult to manage the gap between the top wall of the flow regulating plate and the silicon substrate. Further, if the top wall of the flow regulating plate (upper cup) deforms severely, there is the possibility of contacting the reverse surface of the silicon substrate, and this too must be avoided.

### SUMMARY

In view of the aforementioned, the present invention provides a chemical liquid recovery cup and a chemical liquid coating device that can correct or suppress deformation of the top wall of an upper cup.

A chemical liquid recovery cup relating to the present invention is mounted to the chemical liquid coating device that supplies and coats a chemical liquid on a surface of a substrate while rotating a rotating chuck that holds the substrate, the chemical liquid recovery cup recovering chemical liquid that scatters from the substrate, and has: an upper cup at which the rotating chuck passes-through a through-hole that is formed in a top wall of the upper cup, and a top surface of the top wall faces a reverse surface of the substrate; and a deformation correcting member formed to have higher rigidity than the top wall, and mounted to the top wall along a hole edge portion of the through-hole.

A chemical liquid coating device relating to the present invention supplies and coats a chemical liquid on a surface of a substrate while rotating a rotating chuck that holds the substrate, and recovers chemical liquid that scatters from the substrate by a chemical liquid recovery cup having: an upper cup at which the rotating chuck passes-through a through-hole that is formed in a top wall of the upper cup, and a top surface of the top wall faces a reverse surface of the substrate; and a deformation correcting member formed to have higher rigidity than the top wall, and mounted to the top wall along a hole edge portion of the through-hole.

### BRIEF DESCRIPTION OF THE DRAWINGS

An exemplary embodiment of the present invention will be described in detail based on the following figures, wherein:

FIG. 1 is a longitudinal sectional view showing the structure of main portions of a resist coating device relating to an exemplary embodiment of the present invention;

FIG. 2 is a perspective view showing an upper cup and a lower cup of a coater cup that is a structural member of the resist coating device relating to the exemplary embodiment of the present invention;

FIG. 3 is a plan view of the upper cup shown in FIG. 2;

FIG. 4A is a plan view showing deformation correcting hardware relating to the exemplary embodiment of the present invention;

FIG. 4B is a side view showing the deformation correcting hardware relating to the exemplary embodiment of the present invention;

FIG. 5 is an enlarged sectional view in which a portion of FIG. 1 is enlarged;

FIG. 6A is a plan view showing the upper cup to which a deformation correcting member is not mounted;

FIG. 6B is a side view showing the upper cup to which the deformation correcting member is not mounted;

FIG. 7A is a plan view showing the upper cup to which the deformation correcting hardware is mounted;

FIG. 7B is a side view showing the upper cup to which the deformation correcting hardware is mounted; and

FIG. 8 is a graph showing results of actual measurement of the heights of the upper cups.

### DETAILED DESCRIPTION

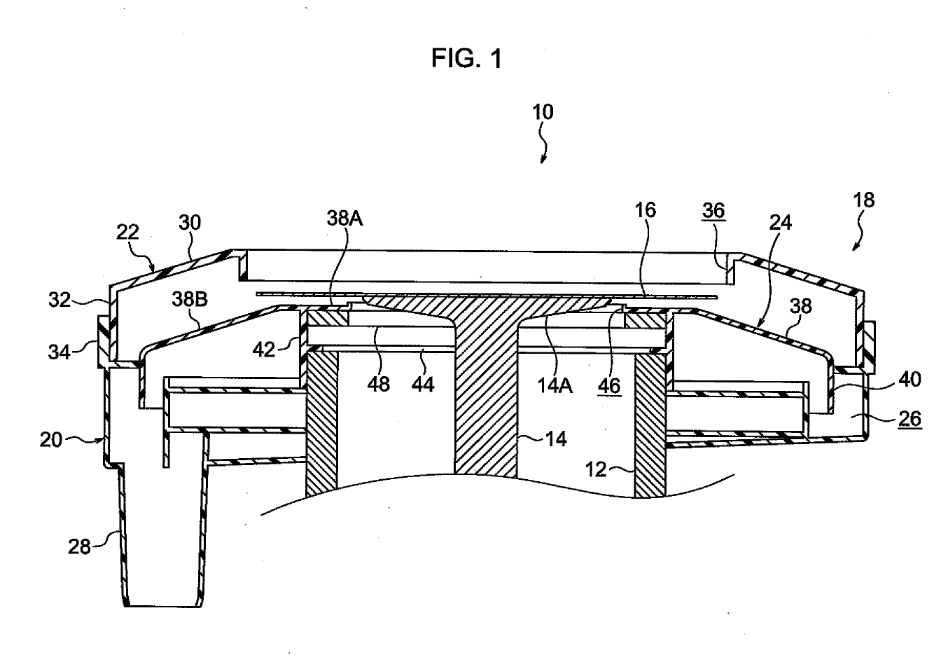

An exemplary embodiment of the present invention is described hereinafter with reference to FIG. 1 through FIG. 8.

FIG. 1 is a sectional view showing the structure of main portions of a resist coating device 10 that serves as a chemical liquid coating device relating to an exemplary embodiment of the present invention. This resist coating device 10 is a device (a so-called spin coater) that is used in photoresist coating processing in a photolithography step that is a step of fabricating a semiconductor integrated circuit. The resist coating device 10 has a base 12 that is formed in the shape of a cylindrical tube. The base 12 is disposed such that the axial direction thereof runs along the vertical direction of the resist coating device 10. A spinner chuck 14 is disposed coaxially at the inner side of the base 12.

The upper end portion of the spinner chuck 14 projects-out upward of the base 12, and a plate-shaped attracting portion 14A is provided at this portion that projects-out. A silicon substrate (wafer) 16 is held at the top surface of this attracting portion 14A by vacuum attraction. The spinner chuck 14 is structured so as to be rotated around a vertical axis and so as to be raised and lowered vertically by the driving force of an unillustrated motor. Note that FIG. 1 illustrates a state in which the spinner chuck 14 has been lowered to its lower limit position of the range of raising and lowering. Further, although not illustrated, a nozzle for dripping (supplying) a photoresist liquid (chemical liquid) onto the surface of the silicon substrate 16 is provided above the spinner chuck 14.

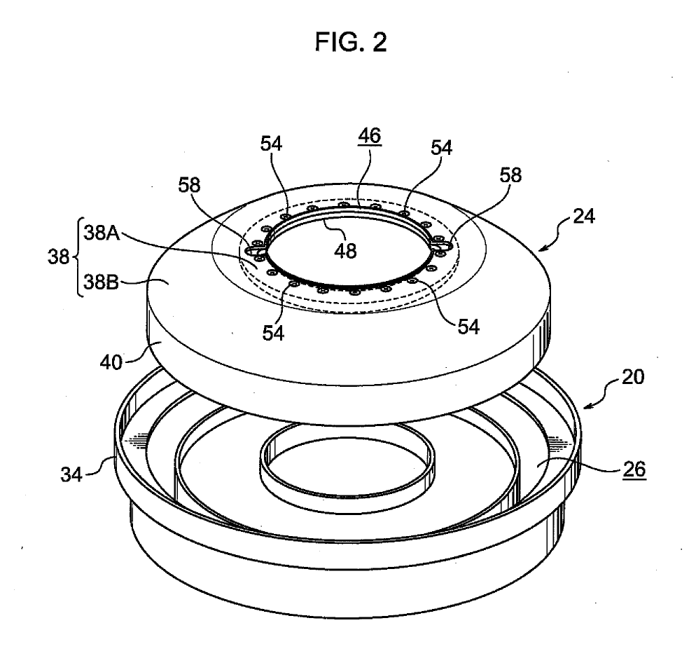

A coater cup 18 serving as a chemical liquid recovery cup is provided at the resist coating device 10. The coater cup 18 has a lower cup 20, a cover cup 22, and an upper cup 24. (Note that illustration of the cover cup 22 is omitted in FIG. 2.) All of these cups are formed from a resin material (polyethylene in the present exemplary embodiment).

The lower cup 20 is formed in a substantial disc shape, and is mounted to the base 12 in a state in which the base 12 is fit-together with a through-hole that is formed in the central portion of the lower cup 20. An annular waste liquid groove 26 is provided at the outer peripheral side of the lower cup 20. Further, a tubular waste liquid opening 28, that communicates with the waste liquid groove 26, is provided at the outer peripheral side of the lower cup 20. A waste liquid tank is connected to the waste liquid opening 28 via a waste liquid hose (neither the tank nor the hose is illustrated).

On the other hand, the cover cup 22 has a top wall 30 and a side wall 32, and is formed in a substantial disc shape. The cover cup 22 is disposed at the upper side of the lower cup 20, and is supported by the lower cup 20 due to the side wall 32 being fit-together with the inner side of a side wall 34 of the lower cup 20.

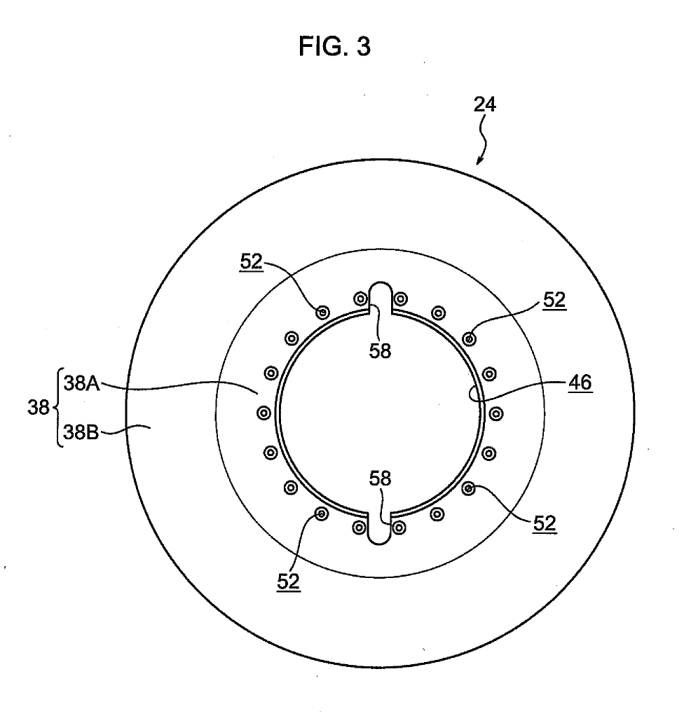

A circular through-hole 36 is formed in the central portion of the top wall 30 of the cover cup 22 (see FIG. 3). The through-hole 36 is a through-hole through which the silicon substrate 16 passes at times when the spinner chuck 14 is raised and lowered. In the state in which the spinner chuck 14 is raised to its upper limit position of the range of raising and lowering, the silicon substrate 16 is, together with the attracting portion 14A, disposed at the upper side of the cover cup 22. Note that the top wall 30 of the cover cup 22 is inclined so as to become lower toward the radial direction outer side.

On the other hand, the upper cup 24 has a top wall 38 and a side wall 40, and is formed substantially in the shape of a disc having a smaller diameter than the lower cup 20 and the cover cup 22. The upper cup 24 is disposed between the lower cup 20 and the cover cup 22, at the lower side of the silicon substrate 16. The wall thickness of the upper cup 24 is set to be around 1 mm in the present exemplary embodiment.

A tubular portion 42 that is formed in the shape of a tube is provided integrally and coaxially with the lower surface side of the top wall 38 of the upper cup 24. The tubular portion 42 projects-out downward from the bottom surface of the top wall 38, and the upper end portion of the base 12 is fit-together with the inner side of the tubular portion 42. A ring-shaped abutting portion 44, that projects-out toward the radial direction inner side, is provided at the inner periphery of the tubular portion 42. Due to the abutting portion 44 abutting the top end surface of the base 12, the upper cup 24 is supported by the base 12.

As shown in FIG. 3, a circular through-hole 46 is formed in the central portion of the top wall 38. The upper end portion of the spinner chuck 14 passes-through the through-hole 46. The reverse surface of the silicon substrate 16, that is held at the attracting portion 14A of the spinner chuck 14, is disposed so as to face the top surface of the top wall 38.

The through-hole 46 of the top wall 38 is formed to have a larger diameter than the attracting portion 14A and a smaller diameter than the tubular portion 42. The hole edge portion of the through-hole 46 is pushed-out in a cantilevered state in cross-section from the top end of the tubular portion 42 toward the radial direction inner side. Hereinafter, this pushed-out portion is called a “pushed-out portion 38A”. Note that the outer peripheral side of the top wall 38 is an inclined portion 38B that is inclined so as to become lower toward the radial direction outer side.

A deformation correcting hardware 48 (deformation correcting member), that is formed in the shape of a ring, is mounted to the bottom surface of the pushed-out portion 38A of the top wall 38. In the present exemplary embodiment, the deformation correcting hardware 48 is formed of aluminum that has been subjected to alumite treatment, and is formed to have higher rigidity than the pushed-out portion 38A. The deformation correcting hardware 48 is formed such that the outer diameter thereof is substantially equal to the inner diameter of the tubular portion 42, and the inner diameter thereof is substantially equal to the inner diameter of the through-hole 46.

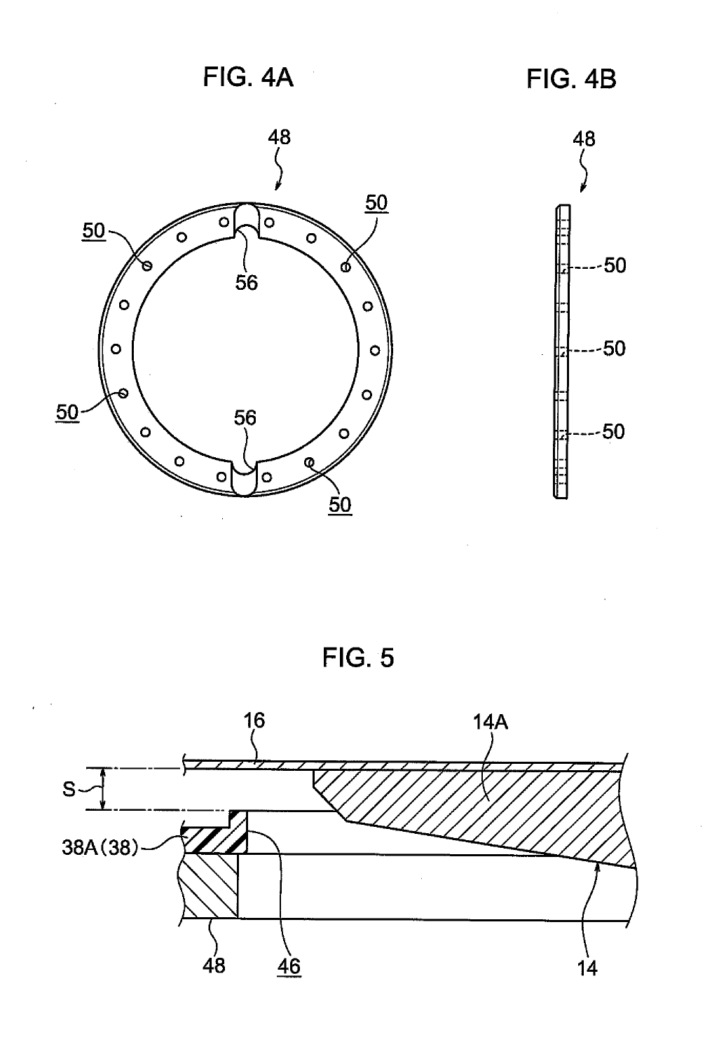

As shown in FIG. 4A and FIG. 4B, plural (18 in the present exemplary embodiment) screw holes 50, that pass-through in the direction of plate thickness, are formed in the deformation correcting hardware 48. The screw holes 50 are disposed so as to be lined-up at a uniform interval along the peripheral direction of the deformation correcting hardware 48. In correspondence with these screw holes 50, plural (18 in the present exemplary embodiment) insert-through holes 52, that pass-through in the direction of plate thickness, are formed in the pushed-out portion 38A of the top wall 38 as shown in FIG. 3. The insert-through holes 52 are disposed so as to be lined-up at a uniform interval along the peripheral direction of the through-hole 46. Flat-head screws 54 (see FIG. 2) are respectively inserted-through the insert-through holes 52 from the top surface side of the top wall 38, and the respective flat-head screws 54 are screwed-together with the respective screw holes 50 of the deformation correcting hardware 48. Due thereto, the deformation correcting hardware 48 is fastened to the bottom surface of the top wall 38 in a state in which the outer peripheral surface of the deformation correcting hardware 48 snugly contacts the inner peripheral surface of the tubular portion 42. Note that countersinking processing is carried out on the respective insert-through holes 52, such that the head portions of the flat-head screws 54 do not project-out from the top surface of the pushed-out portion 38A (see FIG. 2).

A pair of cut-outs 56 (see FIG. 4A) are formed in the top surface of the deformation correcting hardware 48. A pair of cut-outs 58 (see FIG. 3) are formed in the pushed-out portion 38A, in correspondence with the cut-outs 56. These cut-outs 56, 58 are for the placing of an unillustrated nozzle that is for blowing-out a chemical liquid such as thinner or the like toward the reverse surface of the silicon substrate 16. The cut-outs 56, 58 are disposed at opposite sides of one another in the radial direction of the deformation correcting hardware 48 (the radial direction of the through-hole 46).

Note that, in the present exemplary embodiment, the placement, dimensions and the like of the respective structural members are managed such that a gap S (see FIG. 5) between the silicon substrate 16 and the top wall 38 is within a range of 2 mm±0.5 mm in the state in which the spinner chuck 14 has been lowered to its lower limit position of the range of raising and lowering.

Operation and effects of the present exemplary embodiment are described next.

In the resist coating device 10 of the above-described structure, when a photoresist liquid is to be coated on the silicon substrate 16, first, the spinner chuck 14 is raised to its upper limit position of the range of raising and lowering, and the silicon substrate 16 is attracted to and held at the attracting portion 14A of the spinner chuck 14. Then, the spinner chuck 14 is, together with the silicon substrate 16, lowered to its lower limit position (the position shown in FIG. 1) of the range of raising and lowering, and is rotated by an unillustrated motor.

In this state, a photoresist liquid is made to drip down from an unillustrated nozzle onto the surface (the top surface in FIG. 1) of the silicon substrate 16. The photoresist liquid, that has dripped-down onto the surface of the silicon substrate 16, is coated uniformly on the surface of the silicon substrate 16 by centrifugal force. At this time, the excess photoresist liquid becomes spray from the outer peripheral edge of the silicon substrate 16 and scatters in the horizontal direction, and is guided by the top wall 30 of the cover cup 22 and the inclined portion 38B of the upper cup 24, and flows down into the waste liquid groove 26 of the lower cup 20. The photoresist liquid that has flowed down into the waste liquid groove 26 is recovered in the unillustrated waste liquid tank via the waste liquid opening 28 and the unillustrated waste liquid hose.

Here, in the coater cup 18 of the resist coating device 10 relating to the present exemplary embodiment, the deformation correcting hardware 48 is mounted to the pushed-out portion 38A of the top wall 38 of the upper cup 24. Because the deformation correcting hardware 48 is formed to have higher rigidity than the pushed-out portion 38A, deformation of the pushed-out portion 38A can be suppressed by the deformation correcting hardware 48. Due thereto, the height of the upper cup 24 is stable, and management of the gap S between the top wall 38 of the upper cup 24 and the silicon substrate 16 is easy. Further, the pushed-out portion 38A deforming and contacting the reverse surface of the silicon substrate 16 also can be avoided.

With regard to the effects of the deformation correction by the deformation correcting hardware 48, results of actual measurement of the height of the upper cup 24 are set forth and described hereinafter.

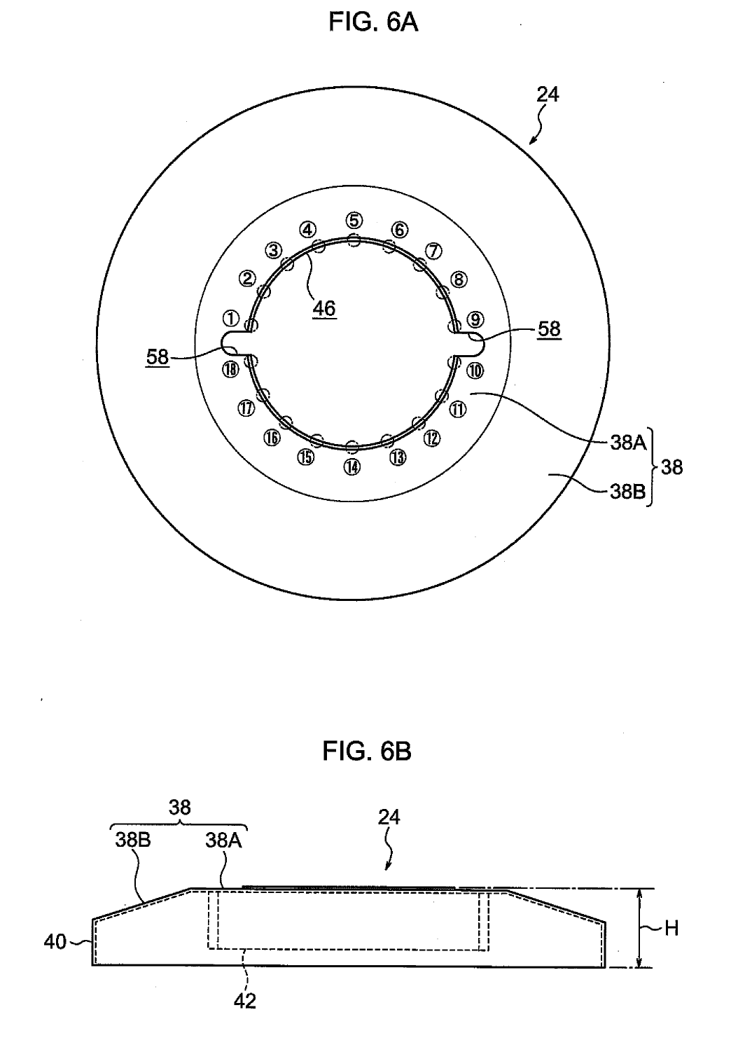

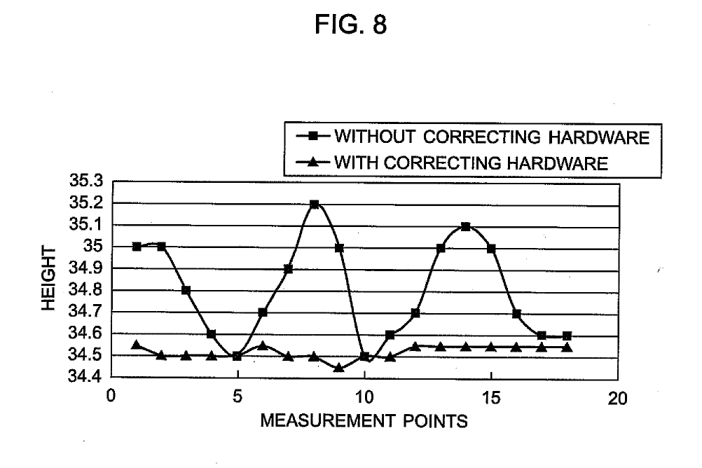

First, as shown in FIG. 6A and FIG. 6B, at the upper cup 24 to which the deformation correcting hardware 48 is not mounted, when a height H shown in FIG. 6B is measured at each of measurement points that are numbered 1 through 18 in FIG. 6A (the centers of the one-dot chain line circles), the results of measurement that are shown by the ▪ marks in FIG. 8 are obtained.

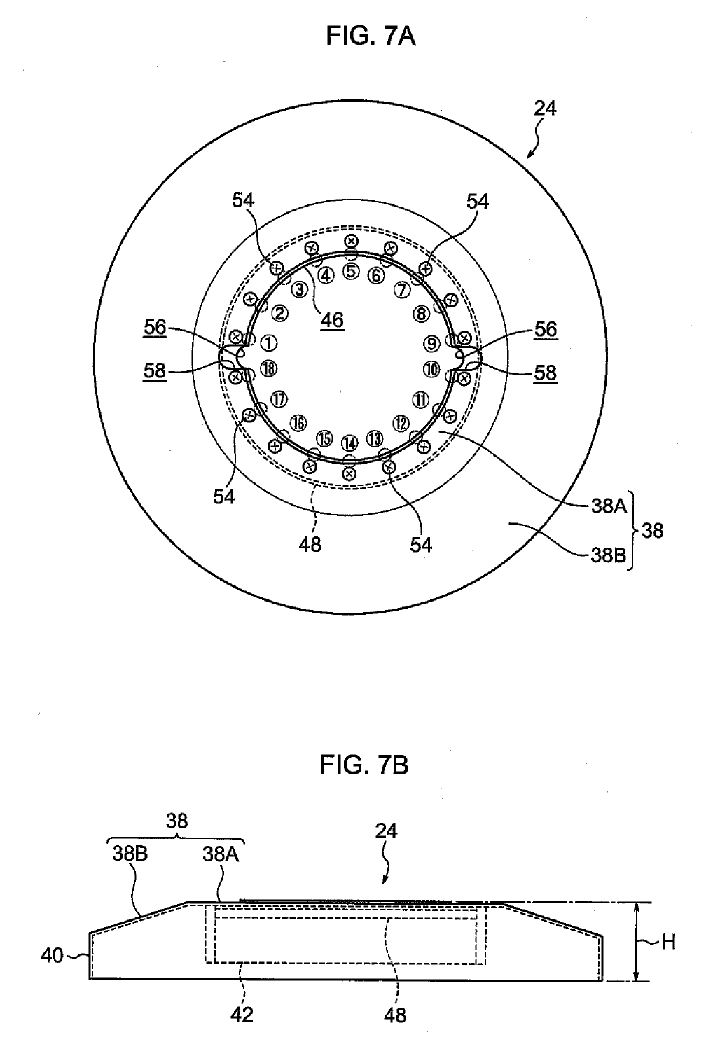

Further, as shown in FIG. 7A and FIG. 7B, at the upper cup 24 to which the deformation correcting hardware 48 is mounted, when the height H shown in FIG. 7B is measured at each of measurement points that are numbered 1 through 18 in FIG. 7A (the centers of the one-dot chain line circles), the results of measurement that are shown by the ▴ marks in FIG. 8 are obtained. Note that the height H of the upper cup 24 is set to be 35 mm from the standpoint of design. Further, in both of the above-described cases, a slide caliper is used in measuring.

As can be understood from FIG. 8, at the upper cup 24 to which the deformation correcting hardware 48 is not mounted (refer to the ▪ marks in FIG. 8), the height H greatly varies depending on the measurement point. This is due to the pushed-out portion 38A, whose plate thickness is thin, deforming.

In contrast, it can be understood that, at the upper cup 24 to which the deformation correcting hardware 48 is mounted (refer to the ▴ marks in FIG. 8), there is hardly any dispersion in the heights H in accordance with the measurement points, and the heights H are substantially uniform at all of the measurement points.

From the above-described results of actual measurement, it is confirmed that the deformation correcting hardware 48 is effective in eliminating deformation of the pushed-out portion 38A. Namely, in the present exemplary embodiment, by mounting the deformation correcting hardware 48 to the upper cup 24 whose pushed-out portion 38A has deformed severely, the deformation of the top wall 38 can be corrected (rectified). Accordingly, the upper cup 24 whose pushed-out portion 38A has deformed severely can be recycled and effectively utilized, which is ideal. Further, by mounting the deformation correcting hardware 48 to the upper cup 24 at which there is little deformation of the pushed-out portion 38A, deformation of the pushed-out portion 38A can be suppressed (prevented) over a long period of time.

Further, in the present exemplary embodiment, the deformation correcting hardware 48 is mounted to the bottom surface of the top wall 38. Accordingly, the deformation correcting hardware 48 interfering with the reverse surface of the silicon substrate 16 can be avoided. Further, the deformation correcting hardware 48 does not affect the managing of the gap S between the top wall 38 and the silicon substrate 16, which is ideal.

In the present exemplary embodiment, because the outer peripheral surface of the deformation correcting hardware 48 abuts the inner peripheral surface of the tubular portion 42 of the upper cup 24, the deformation correcting hardware 48 is supported from the side by the tubular portion 42. Due thereto, the top wall 38 (the pushed-out portion 38A), to which the deformation correcting hardware 48 is mounted, flexing toward the lower side can be suppressed. Accordingly, for this reason as well, managing of the gap S can be made to be easy.

Further, in the present exemplary embodiment, the deformation correcting hardware 48 is fastened to the top wall 38 by the plural flat-head screws 54 that are lined-up along the hole edge portion of the through-hole 46. Therefore, the top wall 38 can be made to snugly contact the deformation correcting hardware 48 well, and thus, deformation of the top wall 38 can be suppressed well. Moreover, the members for mounting the deformation correcting hardware 48 to the top wall 38 do not project-out from the top surface of the top wall 38, which is ideal.

Note that the above-described exemplary embodiment is structured such that the deformation correcting hardware 48 is mounted to the bottom surface of the top wall 38, but the present invention is not limited to the same. If the deformation correcting hardware 48 is formed to have a thin wall-thickness and high rigidity, the deformation correcting hardware 48 may be mounted to the top surface of the top wall 38.

Further, the above exemplary embodiment is structured such that the outer peripheral surface of the deformation correcting hardware 48 abuts the inner peripheral surface of the tubular portion 42, but the present invention is not limited to the same and may be structured such that a gap is provided between the deformation correcting hardware 48 and the inner peripheral surface of the tubular portion 42.

The above-described exemplary embodiment is structured such that the deformation correcting hardware 48 is fastened to the top wall 38 by the plural flat-head screws 54 that are lined-up along the peripheral direction of the through-hole 46. However, the present invention is not limited to the same, and the method of mounting the deformation correcting hardware 48 to the top wall 38 can be changed appropriately.

Further, although the above exemplary embodiment is structured such that the deformation correcting hardware 48 (the deformation correcting member) is formed of aluminum, the present invention is not limited to the same. It suffices for the deformation correcting member to have higher rigidity than the pushed-out portion 38A (the top wall 38), and the deformation correcting member may be formed of another type of material other than metal.

The present invention is described above by using the exemplary embodiment as an example, but the above exemplary embodiment is one example, and various changes can be made within a scope that does not deviate from the gist of the present invention. Further, the scope of the present invention is, of course, not limited to the above-described exemplary embodiment.

What is claimed is:

1. A chemical liquid recovery cup that is mounted to a chemical liquid coating device that supplies and coats a chemical liquid on a surface of a substrate while rotating a rotating chuck that holds the substrate, the chemical liquid recovery cup recovering chemical liquid that scatters from the substrate, and comprising:
an upper cup at which the rotating chuck passes-through a through-hole that is formed in a top wall of the upper cup, and a top surface of the top wall faces a reverse surface of the substrate; and
a deformation correcting member formed to have higher rigidity than the top wall, and mounted to the top wall along a hole edge portion of the through-hole.

2. The chemical liquid recovery cup of claim 1, wherein the deformation correcting member is mounted to a bottom surface of the top wall.

3. The chemical liquid recovery cup of claim 2, wherein the upper cup has a tubular portion that projects-out downward from the bottom surface of the top wall and that is supported at the chemical liquid coating device, and an outer peripheral surface of the deformation correcting member abuts an inner peripheral surface of the tubular portion.

4. The chemical liquid recovery cup of claim 3, wherein an outer diameter of the deformation correcting member is substantially equal to an inner diameter of the tubular portion, and an inner diameter of the deformation correcting member is formed to be substantially equal to an inner diameter of the through-hole.

5. The chemical liquid recovery cup of claim 1, wherein the deformation correcting member is fastened to the top wall by a plurality of screws that are lined-up along a peripheral direction of the through-hole.

6. The chemical liquid recovery cup of claim 1, wherein
a cut-out is formed in a top surface of the deformation correcting member, and
a cut-out, that corresponds to the cut-out, is formed in the top wall of the upper cup.

7. The chemical liquid recovery cup of claim 6, wherein a pair of the cut-outs are provided at the deformation correcting member and are disposed at opposite sides with respect to one another, and a pair of the cut-outs are provided at the upper cup and are disposed at opposite sides with respect to one another.

8. The chemical liquid recovery cup of claim 1, wherein the upper cup is formed of a resin material.

9. The chemical liquid recovery cup of claim 1, wherein the deformation correcting member is formed of aluminum that has been subject to alumite treatment.

10. A chemical liquid coating device that supplies and coats a chemical liquid on a surface of a substrate while rotating a rotating chuck that holds the substrate, and that recovers, by the chemical liquid recovery cup of claim 1, chemical liquid that scatters from the substrate.
